(19) United States
(12) Patent Application Publication
(10) Pub. No.: US 2008/0057961 A1
(43) Pub. Date: Mar. 6, 2008

(54) Method for Receiving Multimedia Broadcast/Multicast Service

(75) Inventors: Chunying Sun, Beijing (CN); Xiaoqiang Li, Beijing (CN)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si, Gyeonggi-do (KR); BEIJING SAMSUNG TELECOM R & D CENTER, Haidian District, Beijing (CN)

(21) Appl. No.: 11/666,898

(22) PCT Filed: Nov. 2, 2005
(86) PCT No.: PCT/KR05/03663

§ 371 Date: Oct. 30, 2007

(30) Foreign Application Priority Data
Nov. 2, 2004 (CN) 200410088763.2

(51) Int. Cl. H04Q 7/20

(52) U.S. Cl. 455/436

(57) ABSTRACT

A method for receiving Multimedia Broadcast/Multicast Service, the method including a SRNC sends a message to a UE that is in a connected state in the CS domain and in a idle state in the PS domain, the message informing the user of the UE of establishing a signaling connection in the PS domain for the MBMS service; upon receiving this message, the UE sends a “Service Request” message to a core network, the service type included in this message being “MBMS paging response”; a SGSN sends a “MBMS UE Connection Request” message to the SRNC.

### BACKGROUND OF THE INVENTION

1. Field of the Invention

The present invention relates to a method for providing Multimedia Broadcast/Multicast Service (hereinafter referred to as MBMS) in the Wideband Code Division Multiple Access (hereinafter referred to as WCDMA) mobile communication system, especially to a method for providing MBMS service for a User Equipment (hereinafter referred to as UE) which are in a connected state in circuit domain (hereinafter referred to as CMM_CONNECTED) and in an idle state in packet domain (hereinafter referred to as PMM_IDLE).

2. Description of the Prior Art

The Multimedia Broadcast/Multicast Service (hereinafter referred to as MBMS) is a new service under standardization by 3G Mobile Communication System Partnership Project (hereinafter referred to as 3GPP). MBMS service is a unidirectional point-to-multipoint service. The most remarkable feature of the service consists in that it can make use of radio resources and network resources efficiently.

FIG. 1 describes a MBMS system structure. MBMS network structure, based on the core network of General Packet Radio Service (hereinafter referred to as GPRS), is added with new network elements. The description of the MBMS system structure in FIG. 1 is as follows.

Broadcast and Multicast Service Center 101 (hereinafter referred to as BM-SC) is a service control center of the MBMS system. Gateway GPRS Supporting Node 102 (hereinafter referred to as GGSN) and Service GPRS Supporting Node 103 (hereinafter referred to as SGSN) constitute a transmission network of MBMS service and provide route for a data transfer. UMTS Terrestrial Radio Access Network 104 (hereinafter referred to as UTRAN) provides radio resources for the MBMS service over the air-interface. User Equipment 105 (hereinafter referred to as UE) is a terminal device for receiving data. Home Location Register 106 (hereinafter referred to as HLR) saves data related to the user and can provide services such as user authentication. Uu107 is a radio interface, and Iu108 represents an interface between the access network and the core network. The radio resources used by MBMS service are not dedicated for one user, but shared by all users using this service.

FIG. 3 illustrates a signaling flow chart for the UE to switch from the CMM_CONNECTED/PMM_IDLE state into the PMM_CONNECTED state in the current system. At 301, a UE establishes a CS domain call to enter the connected state in the CS domain (CMM_CONNECTED), and the PS domain still remains in the idle state (PMM_IDLE). At 302, at this moment, if a service is to be transmitted in the PS domain, it is necessary for the UE to enter the PMM_CONNECTED state. At 303, now, a Service Radio Network Controller (hereinafter referred to as SRNC) in the UE sends a RRC message “Paging type 1” or “Paging type 2” to the UE, including a paging type. The well defined paging type comprises a Terminating Conversational Call, a Terminating Streaming Call, a Terminating Interactive Call, a Terminating Background Call, a Terminating High Priority Signaling, a Terminating Low Priority Signaling and a Terminating-cause unknown. At 304, when the RRC layer of the UE receives this paging message, it submits the paging type information to the higher layer of the is RRC layer. At 305, according to the paging type information, the higher layer of the RRC layer determines to establish a signaling connection in the PS domain, and sends this command to the RRC. At 306, the UE sends a “Service Request” message to SGSN via a forward by SRNC (which is implemented in step 307). Based on the currently available criterions, the paging type carried in the “Service Request” message can be “data”, “signaling”, “paging response”, or “MBMS paging response”.

Upon providing a MBMS service for a UE, the UE usually receives a MBMS related signaling via a Multicast Control Channel (MCCH) initiated from the CRNC. But for the UE in the CMM_CONNECTED/PMM_IDLE state, the reception of the MBMS related information is usually performed via a Dedicated Control Channel (DCCH). In the present invention, the message is transmitted from SRNC to the UE via the DCCH.

In the prior art, if the UE remains in the CMM_CONNECTED state and is required to switch into the state of PMM_CONNECTED for MBMS service, the UE has no idea that the service type is MBMS. Therefore, it is impossible for the UE to set the service type as “MBMS paging response” in the “Service Request” message, causing the abnormality of the operation of the SGSN.

### SUMMARY OF THE INVENTION

An object of the present invention is to provide a method allowing the UE to know that the reason why it should enter a PMM_CONNECTED state is just for the MBMS service so as to ensure the normal operation of a SGSN on the network side.

The invention provides a method for receiving Multimedia Broadcast/Multicast Service, comprising following steps:

a SRNC sends a message to a UE that is in a connected state in the CS domain and in a idle state in the PS domain, the message informing the user of the UE of establishing a signaling connection in the PS domain for the MBMS service;

upon receiving this message, the UE sends a “Service Request” message to a core network, the service type included in this message being “MBMS paging response”;

a SGSN sends a “MBMS UE Linking Request” message to the SRNC.

In the present invention, by adding a RRC message from the SRNC to the UE or adding a new information element to the existing RRC message, the UE is allowed to be aware that the signaling connection is established for the MBMS service. Therefore, the UE sends the correct message to the core network to ensure the normal operation of the core network node SGSN.

### BRIEF DESCRIPTION OF THE DRAWINGS

The above and other features and advantages of the present invention will become more apparent by describing in detail exemplary embodiments thereof with reference to the attached drawings in which:

FIG. 1 is a logical diagram illustrating for a network device for MBMS service;

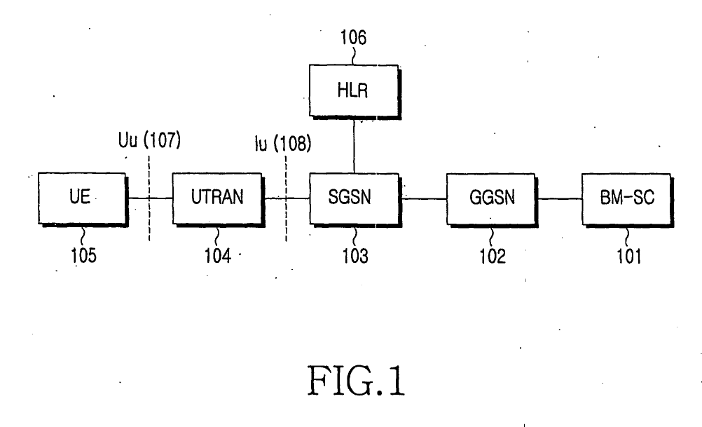

FIG. 2 is a flow chart according to the present invention;

FIG. 3 is a flow chart according to prior art;

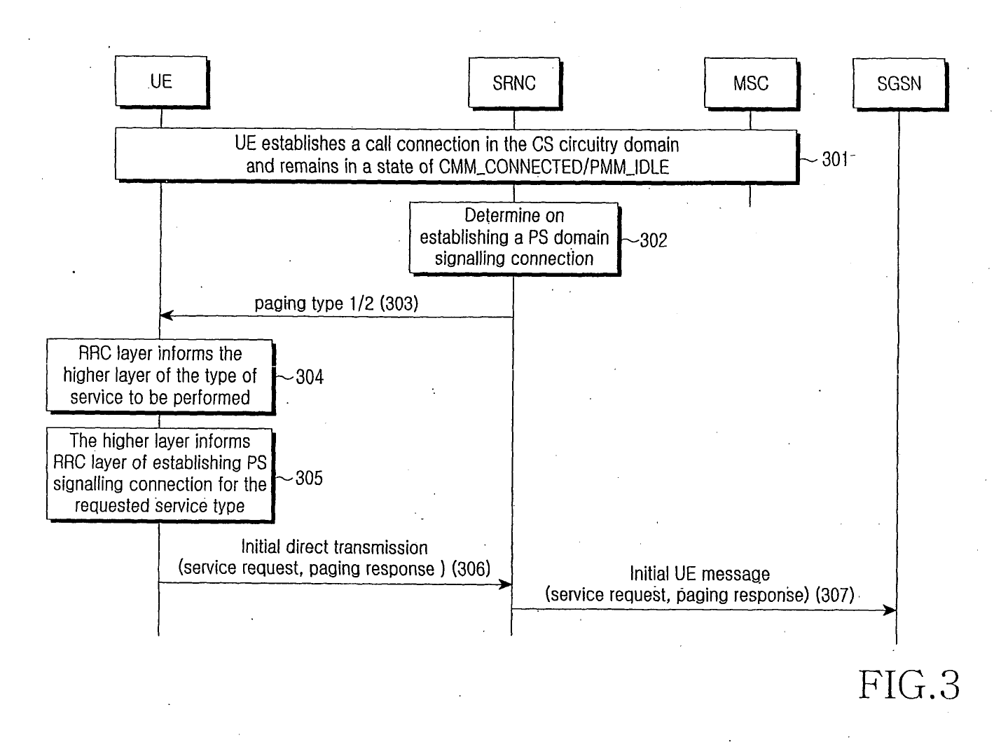

FIG. 4 is a diagram illustrating the operations performed in the UE and the SGSN.

### DETAILED DESCRIPTION OF THE INVENTION

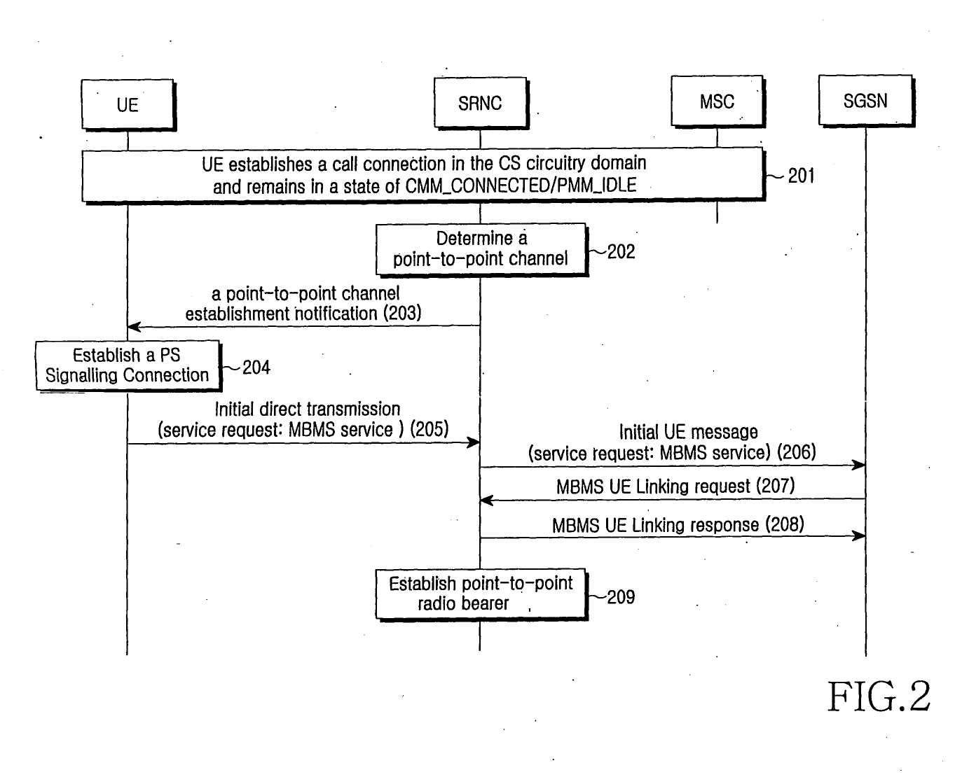

The invention provides a method by which the UE is informed to switch from the CMM_CONNECTED/PMM_IDLE state into the PMM_CONNECTED state for MBMS service. FIG. 2 illustrates a flow chart for SRNC to send a message to the UE to make it switch into the state of PMM_CONNECTED.

At 201, due to a call in the CS domain, the UE enters the state of CMM_CONNECTED/PMM_CONNECTED. At this moment, there is no signaling connection between the UE and the core network node SGSN in the PS domain. If the UE switches into the state of PMM_CONNECTED, a signaling connection will be established between the UE and the SGSN. At 202, if at this time, a MBMS service is initiated and the channel type is determined as the point-to-point mode, or the UE is receiving the MBMS service in the mode of point-to-multipoint and the channel type corresponding to the service is being switched from the point-to-multipoint mode into the point-to-point mode (this information can be obtained by a SRNC of the UE, through its statistical data or from a DRNC of the UE), the SRNC sends a “Point-to-point Channel Establishment Notification” to the UE at 203, including the MBMS service identifier. AT 204, the UE prepares to establish a signaling connection in the PS domain, and sends a “Service Request” message to the core network CN at 205. This message is forwarded to SGSN by SRNC at 206. In this message, the “Service Type” is set as “MBMS paging response”. Once SGSN receives this message, it knows that the reason why the UE switches into the state of PMM_CONNECTED is for the purpose of MBMS service. So, the SGSN sends “MBMS UE Linking Request” message to the SRNC at 207, the SRNC sends “MBMS UE Linking Response” message to the SGSN at 208, informing SRNC of all the MBMS services that the UE has joined in. Then, the SRNC can establish a point-to-point channel at 209, to provide MBMS service for the UE in the mode of point-to-point. The message at 203 can be either a new one or the existing one such as “Paging type 1” or “Paging type 2”, the paging cause of which is set as a new value: Terminating MBMS call.

### One Embodiment According to the Invention

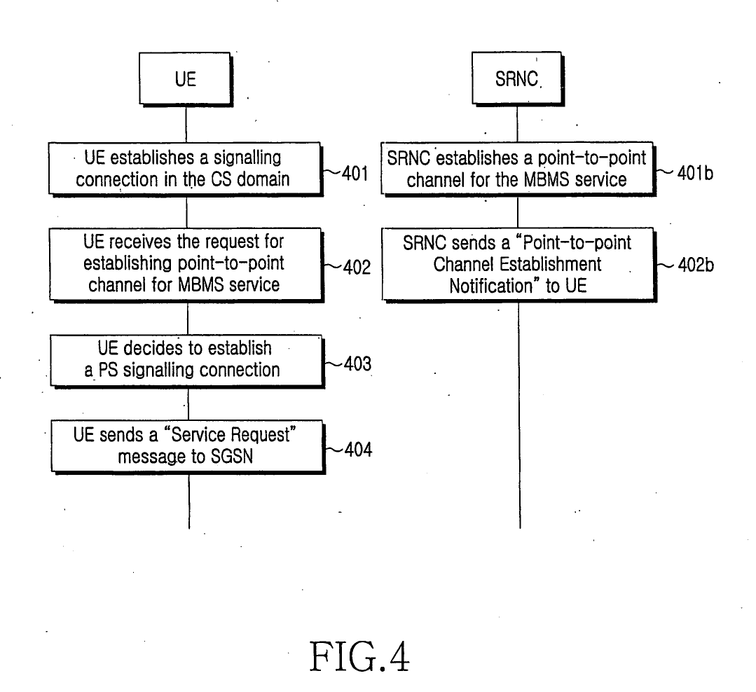

FIG. 4 illustrates the operations performed between the UE and the SRNC. At 401, the UE initiates a CS call and enters the state of CMM_CONNECTED/PMM_IDLE. At this moment, there is no signaling connection between the UE and the core network node SGSN in the PS domain. If the UE switches into the state of PMM_CONNECTED, a signaling connection will be established between the UE and the SGSN. At 401a, once the SRNC of the UE makes determination to establish a point-to-point channel for MBMS service through its own statistical data or from the DRNC of the UE. At 402b, the SRNC sends a “Point-to-point Channel Establishment Notification” message to the UE. On the UE side, it receives a request for establishing point-to-point channel for the MBMS service from SRNC at 402. AT 403, the UE decides to establish a signaling connection in the PS domain, and then sends a “Service Request” message to the core network at 404.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for receiving Multimedia Broadcast/Multicast Service, comprising following steps:
a SRNC sends a message to a UE that is in a connected state in the CS domain and in a idle state in the PS domain, the message informing the user of the UE of establishing a signaling connection in the PS domain for the MBMS service;
upon receiving this message, the UE sends a “Service Request” message to a core network, the service type included in this message being “MBMS paging response”;
a SGSN sends a “MBMS UE Connection Request” message to the SRNC.

2. The method as defined in claim 1, wherein the message that being sent to the UE is a new message “Point-to-point Channel Establishment Request”.

3. The method as defined in claim 1, wherein the message that being sent to the UE is an existing message “Paging type 1” or “Paging type 2”.

4. The method as defined in claim 2, wherein the message that being sent to the UE includes a parameter “MBMS Service Identifier”.

5. The method as defined in claim 3, wherein the paging type included in the message “Paging type 1” or “Paging type 2” that being sent to the UE is set as “Terminating MBMS call”.

6. The method as defined in claim 1, wherein the message that being sends to the UE is transmitted via the dedicated control channel (DCCH).
